(19) United States
(12) Patent Application Publication
(10) Pub. No.: US 2025/0360800 A1
(43) Pub. Date: Nov. 27, 2025

(54) ELECTRIC MACHINE CONTROL CIRCUIT, ELECTRIC DRIVE ASSEMBLY SYSTEM AND VEHICLE

(71) Applicant: VALEO EAUTOMOTIVE GERMANY GMBH, Erlangen (DE)

(72) Inventors: Ye Jin JIN, Erlangen (DE); Renzhe CHEN, Erlangen (DE); Wei ZHU, Erlangen (DE); Anbang XIAO, Erlangen (DE)

(73) Assignee: VALEO EAUTOMOTIVE GERMANY GMBH, Erlangen (DE)

(21) Appl. No.: 18/872,302

(22) PCT Filed: Jun. 5, 2023
(86) PCT No.: PCT/EP2023/065022

§ 371 Date: Dec. 6, 2024

(30) Foreign Application Priority Data
Jun. 8, 2022 (CN) 202210644766.8

(51) Int. Cl. B60L 15/20; B60L 50/51; B60L 50/60; B60L 53/24; H02M 7/5387

(52) U.S. Cl. CPC B60L 15/20; B60L 50/51; B60L 50/60; B60L 53/24; H02M 7/5387; B60L 2210/14; B60L 2210/42; B60L 2220/54

(57) ABSTRACT

An electric machine control circuit, an electric drive assembly system and a vehicle. The electric machine control circuit includes a three-phase AC electric machine; a three-phase inverter, wherein, in an electric machine drive mode, the three-phase inverter is configured to receive DC power from an external power battery and output AC power for driving the three-phase AC electric machine. In a DC boost charging mode, three-phase windings in wire slots of an electric machine stator of the three-phase AC electric machine are used as an inductive energy storage element of a DC boost charging circuit, the inductive energy storage element and the three-phase inverter together forming the DC boost charging circuit, such that an external power supply module charges the external power battery by means of the DC boost charging circuit, wherein the wire slots are at least 54 wire slots.

### TECHNICAL FIELD

The present disclosure relates to the field of electric machine control, in particular to an electric machine control circuit, an electric drive assembly system and a vehicle.

### BACKGROUND

With the widespread use of vehicles and especially electric vehicles in the civilian and commercial sectors, higher requirements have been imposed for vehicle charging processes.

At present, during fast DC charging of a vehicle power battery, when the voltage of a charging post (i.e. an external power supply module) is lower than the voltage of the power battery, a DC boost charging method will be used to charge the power battery, i.e. a DC boost charging circuit is provided between the external power supply module and the power battery, to realize a boost charging process.

However, if an additional DC boost charging circuit is provided, this will significantly increase the structural complexity and volume of the internal circuitry of the vehicle, and the flexibility of the dedicated circuit is low; if an inverter and an AC electric machine of the vehicle are used for the additional purpose of forming a DC boost charging circuit, then with an existing AC electric machine structural configuration, the requirements of the boost charging process can generally not be met by only using the inductance of the three-phase windings of the AC electric machine. Thus, an additional inductive element will generally be further provided in the DC boost charging circuit to realize the boost charging function. However, providing an additional inductive energy storage module will inevitably increase the complexity of the internal circuit structure of the vehicle, thus increasing the manufacturing cost. Furthermore, there is also room to further improve the performance of AC electric machines in existing vehicles, and in particular, there is a need to further increase the output rotation speed of AC electric machines, thus realizing high-rotation-speed electric machines, in order to meet the corresponding drive demands.

Thus, there is a need for an electric machine control circuit capable of realizing a boost charging process of an external power supply module for a power battery in a simple and convenient manner according to actual needs while also realizing effective control of an electric machine of a vehicle, wherein the electric machine control circuit is structurally simple, and has high reliability and flexibility in use. In particular, it is able to realize a boost charging function by means of three-phase windings of an AC electric machine acting as an inductive energy storage element in a DC boost charging circuit, without the need for an additional inductive element, and in particular, the electric machine in the electric machine control circuit may for example have a high output rotation speed.

### SUMMARY

In response to the above problem, the present disclosure provides an electric machine control circuit, an electric drive assembly system and a vehicle.

According to one aspect of the present disclosure, an electric machine control circuit is proposed, comprising: a three-phase AC electric machine; a three-phase inverter, wherein, in an electric machine drive mode, the three-phase inverter is configured to receive DC power from an external power battery and output AC power for driving the three-phase AC electric machine, and in a DC boost charging mode, three-phase windings in wire slots of an electric machine stator of the three-phase AC electric machine are used as an inductive energy storage element of a DC boost charging circuit, the inductive energy storage element and the three-phase inverter together forming the DC boost charging circuit, such that an external power supply module charges the external power battery by means of the DC boost charging circuit, wherein the wire slots are at least 54 wire slots.

In some embodiments, the inductive energy storage element is formed solely by the three-phase windings in the wire slots of the electric machine stator of the three-phase AC electric machine.

In some embodiments, the wire slots are 54 wire slots, 60 wire slots, 66 wire slots or 72 wire slots.

In some embodiments, the electric machine stator has 6 magnetic poles.

In some embodiments, the electric machine stator has 8 magnetic poles, and the wire slots are 72 wire slots.

In some embodiments, in the DC boost charging mode, a first end of the three-phase inverter is electrically connected to the external power battery, and a second end of the three-phase inverter is electrically connected to the external power supply module and the external power battery; and the midpoints of three-phase bridge arms of the three-phase inverter are each connected to a corresponding end of the three-phase windings of the three-phase AC electric machine, with the other ends of the three-phase windings of the three-phase AC electric machine being electrically connected to the external power supply module via a common connection point.

In some embodiments, in the DC boost charging mode, the common connection point of the three-phase windings of the three-phase AC electric machine is electrically connected to the external power supply module, such that no additional inductive element is provided between the common connection point and the external power supply module.

In some embodiments, the nominal rotation speed of the three-phase AC electric machine is at least 17000 r/min.

In some embodiments, the nominal rotation speed of the three-phase AC electric machine is 20000 r/min.

According to another aspect of the present disclosure, an electric drive assembly system is further proposed, comprising the electric machine control circuit as described above.

According to another aspect of the present disclosure, a vehicle is further proposed, comprising the electric drive assembly system as described above.

As a result of using the electric machine control circuit, electric drive assembly system and vehicle provided in the present disclosure, firstly, the electric machine of the vehicle can be controlled effectively by means of the electric machine control circuit; secondly, depending on actual needs, the electric machine control circuit can be used additionally as the DC boost charging circuit, thereby realizing the boost charging process of the external power supply module for the power battery in a simple and convenient manner, and the electric machine control circuit is structurally simple, and highly reliable and flexible in use; and thirdly, the electric machine in the electric machine control circuit can have a high output rotation speed in the drive mode, for pushing the vehicle forward.

### BRIEF DESCRIPTION OF THE DRAWINGS

In order to describe the technical solution of embodiments of the present disclosure more clearly, the drawings to be used in describing the embodiments are briefly described below. Obviously, the drawings described below show only some embodiments of the present disclosure, and those skilled in the art may obtain other drawings based on these drawings without inventive effort. The drawings below have not been drawn meticulously in proportion according to actual dimensions, but focus on showing the substance of the present disclosure.

FIG. 1 shows a schematic block diagram of an electric machine control circuit 100 according to embodiments of the present disclosure.

FIG. 2 shows a circuit diagram of the electric machine control circuit 100 according to embodiments of the present disclosure.

FIG. 3A shows the current flow direction when the electric machine control circuit 100 in FIG. 2 is in a first stage of a DC boost charging mode, in which an external power supply module charges three-phase windings of a three-phase AC electric machine.

FIG. 3B shows the current flow direction when the electric machine control circuit 100 in FIG. 2 is in a second stage of the DC boost charging mode, in which the external power supply module and the three-phase windings of the three-phase AC electric machine together charge the power battery.

FIG. 4 shows a graph comparing the performances of an electric machine with 54 wire slots and 6 poles according to embodiments of the present disclosure and an electric machine with 48 wire slots and 8 poles.

### DESCRIPTION OF THE EMBODIMENTS

The technical solution in embodiments of the present disclosure will be described clearly and completely below with reference to the drawings. Obviously, the embodiments described are merely some, not all, of the embodiments of the present disclosure. All other embodiments obtained by those skilled in the art based on embodiments of the present disclosure without inventive effort shall also fall within the scope of protection of the present disclosure.

As indicated in the present application and claims, unless expressly specified otherwise in the context, words such as “a”, “one”, “one type”, and/or “said” do not specifically mean the singular, and may also include the plural. Generally, the terms “comprise” and “include” only indicate the inclusion of expressly identified steps and elements, but these steps and elements do not constitute an exclusive list, and a method or device may also include other steps or elements.

At present, during fast DC charging of a vehicle power battery, when the voltage of a charging post (i.e. an external power supply module) is lower than the voltage of the power battery, a boost charging method will be used to charge the power battery, i.e. a DC boost charging circuit is provided between the external power supply module and the power battery, to realize a boost charging process.

However, if an additional DC boost charging circuit is provided, this will significantly increase the structural complexity and volume of the internal circuitry of the vehicle, and the flexibility of the dedicated circuit is low; if an inverter and an AC electric machine of the vehicle are used for the additional purpose of forming a DC boost charging circuit, then with an existing AC electric machine structural configuration, the requirements of the boost charging process can generally not be met by only using the inductance of the three-phase windings of the AC electric machine. Thus, an additional inductive element will generally be further provided in the DC boost charging circuit to realize the boost charging function. However, providing an additional inductive energy storage module will inevitably increase the complexity of the internal circuit structure of the vehicle, thus increasing the manufacturing cost. In addition, considering existing drive needs, a further increase in the electric machine's rotation speed is also desired, to realize a high-rotation-speed electric machine.

Thus, the present application proposes an electric machine control circuit capable of realizing a boost charging process of an external power supply module for a power battery in a simple and convenient manner according to actual needs while also realizing effective control of an electric machine of a vehicle, wherein the electric machine control circuit is structurally simple and has high reliability and flexibility in use, and the rotation speed outputted by the electric machine in the electric machine control circuit is higher.

According to one aspect of the present disclosure, an electric machine control circuit 100 is proposed. FIG. 1 shows a schematic block diagram of the electric machine control circuit 100 according to embodiments of the present disclosure.

Referring to FIG. 1, the electric machine control circuit 100 for example comprises: a three-phase AC electric machine 111 and a three-phase inverter 112.

The three-phase AC electric machine 111 is an AC electric machine with three-phase windings, and may for example be a synchronous electric machine or an asynchronous electric machine, e.g. a permanent magnet synchronous electric machine. However, it should be understood that embodiments of the present disclosure are not restricted in terms of the specific electric machine type of the three-phase AC electric machine.

The three-phase inverter 112 is an electronic device for converting DC power to three-phase AC power. For example, the midpoints of the three-phase bridge arms of the three-phase inverter are respectively connected to the three-phase windings of the three-phase AC electric machine, to realize connection of the three-phase inverter to the three-phase AC electric machine. Specifically, the three-phase inverter may comprise 6 switching control elements, which may for example be transistors, MOS transistors or other devices, with each pair of switching control elements together forming a bridge arm of one phase, and the pairs together forming three-phase bridge arms, with the connection point of the two switching control elements in the bridge arm of each phase being connected to the winding of one phase in the three-phase AC electric machine.

However, it should be understood that only one exemplary structure of the three-phase inverter has been given above, and other types of devices, for example IGBT devices, may also be chosen as the switching control elements.

Furthermore, the electric machine control circuit may for example be configured for an electric machine drive mode or a DC boost charging mode. In the electric machine drive mode, the three-phase AC electric machine is subjected to electric machine operation control by means of the three-phase inverter based on a power battery of the vehicle (i.e. an external power battery 200). In the DC boost charging mode, when the power battery 200 of the vehicle needs to be charged, if the charging voltage (e.g. 400-500 V DC) of a connected power supply module (i.e. an external power supply module 300) is not higher than the voltage (500-1000 V DC) of the power battery 200, the power supply module will be unable to charge the power battery completely, and the voltage of the power supply module needs to be boosted before charging the power battery 200.

In the electric machine drive mode, the three-phase inverter is configured to receive DC power from the external power battery 200, and outputs AC power for driving the three-phase AC electric machine.

For example, if the three-phase inverter has three-phase bridge arms and 6 switching control elements, e.g. has two switching control elements in the bridge arm of each phase, and the ON/OFF state of an upper bridge arm and a lower bridge arm in this bridge arm are separately controlled, then at this time it is possible for example to control the current and/or voltage on the winding of each phase in the three-phase AC electric machine connected to the three-phase bridge arms by controlling the ON and OFF states of the six switching control elements, and thereby drive the three-phase AC electric machine based on the external power battery 200.

In the DC boost charging mode, the three-phase windings in wire slots of an electric machine stator of the three-phase AC electric machine are used as an inductive energy storage element of a DC boost charging circuit; the inductive energy storage element and the three-phase inverter together form the DC boost charging circuit, such that the external power supply module 300 charges the external power battery 200 by means of the DC boost charging circuit.

For example, in the DC boost charging mode, the three-phase windings of the three-phase AC electric machine receive DC power from the external power supply module 300, and at the same time are used as the inductive energy storage element of the DC boost charging circuit; the three-phase bridge arms of the three-phase inverter may be controlled to be in a first ON/OFF state, such that the external power supply module 300 first charges the three-phase windings of the three-phase AC electric machine by means of the three-phase inverter; once charging of the three-phase windings of the three-phase AC electric machine has ended, the three-phase bridge arms of the three-phase inverter are controlled to be in a second ON/OFF state, such that the power supply module and the three-phase windings of the three-phase AC electric machine together discharge to the power battery 200; because the three-phase windings also output a voltage in the process of discharging at this time, this is equivalent to superposition of the voltage of the three-phase windings and the voltage of the power supply module, thus realizing the process of boosting the voltage of the external power supply module 300. It is thus possible to effectively realize boost charging of the external power battery 200 by the external power supply module 300.

Moreover, the wire slots are at least 54 wire slots (also called wire slots hereinbelow). The wire slots are wire slots of the electric machine stator of the three-phase AC electric machine, and are intended to accommodate the three-phase windings.

For example, in the case of a three-phase AC electric machine with 48 wire slots, this has 16 wire slots corresponding to the winding of each phase, i.e. the number of series-connected turns of the winding of each phase of the electric machine is 16; when an electric machine with 54 wire slots is used, this has 18 wire slots corresponding to the winding of each phase, i.e. the number of series-connected turns of the winding of each phase of the electric machine is 18. Comparison makes it clear that the number of wire slots of the winding of each phase can be considerably increased by using the structure with 54 wire slots; taking into account the correspondence between the number of wire slots in the stator and the number of series-connected turns of the windings, the number of series-connected turns of the winding of each phase is considerably increased. This will significantly increase the inductance of the winding of each of phase in the three-phase windings.

Thus, in the present application, setting the number of wire slots of the electric machine stator to be at least 54 makes it possible to correspondingly increase the inductance of the three-phase windings, and when the three-phase windings are used as the inductive energy storage element of the DC boost charging circuit, the amount of charge which can be stored in the inductive energy storage element is increased because the electrical energy stored by an inductor is directly proportional to the inductance of the inductor, and hence the power that can be outputted is greater. Thus, performance is better in the process of subjecting the power battery to boost charging. Specifically, the voltage drop of three-phase windings with a larger inductance when outputting a low power will be less than the voltage drop of three-phase windings with a smaller inductance when outputting the same power, so the voltage stability and reliability of the boost charging process can be ensured.

In addition, compared to the 48 wire slots generally used at present, setting the number of wire slots of the electric machine stator to be at least 54 makes it easier to simultaneously give consideration to high rotation speed and high torque output of the electric machine.

Specifically, firstly, the size of the rotor disposed in the electric machine will be reduced by configuring the electric machine to have at least 54 wire slots, and the use of this smaller-radius rotor will help to increase the output rotation speed of the electric machine.

Secondly, despite the smaller-radius rotor, the electric machine torque can still be maintained at a high level to meet the drive requirements, due to the increased number of wire slots (at least 54) in the stator. The process of maintaining a high torque through the setting of at least 54 wire slots is now described in more detail:

Specifically, the expression for the total torque of an electric machine is as follows:

$$Te = \frac{2}{3} * p * ( {φ}_{pm} * {I}_{q} - ( {L}_{d} - {L}_{q} ) * {I}_{q} * {I}_{d} ) \qquad 1 )$$

where Tₑ is the total torque, (L_{d}−L_{q})*I_{q}*I_{d} is the torque arising from the difference in reluctance, i.e. the reluctance torque, φₚₘ*I_{q} is the torque arising from the Lorentz force, and p is the number of magnetic pole pairs in the electric machine.

Based on electric machine operating characteristics and the expression for the total torque of an electric machine, it is known that the total torque of an electric machine is related to several parameters, such as the rotor radius, the number of series-connected turns for each phase (corresponding to the number of wire slots in the stator for each phase), the current and the number of pole pairs.

It is thus known that, if the rotor radius is reduced, setting the number of wire slots in the stator to be at least 54 will significantly increase the number of wire slots compared with the conventional case of 48 wire slots (i.e. increase the number of series-connected turns for each phase), such that the electric machine torque is still maintained at a high level, based on the reduction in rotor outer diameter (achieving a high rotation speed).

Specifically, in a high-rotation-speed electric machine (e.g. with a nominal rotation speed of 17000 r/min or higher), the outer diameter of the electric machine rotor will be further reduced; in this case, while the rotor outer diameter is reduced to increase the rotation speed, setting the number of wire slots to be greater than or equal to 54 makes it possible to maintain the same output torque as in the case where the rotor outer diameter is not reduced.

It should be understood that a greater number of wire slots may be further set according to actual needs, e.g. 60 wire slots, 66 wire slots, etc., to further increase the inductance of the three-phase AC windings and improve the electric machine characteristics.

Based on the above, in the present application, firstly, in the electric machine drive mode, the electric machine control circuit is configured to receive DC power from the external power battery by means of the three-phase inverter and output AC power for driving the three-phase AC electric machine; in this way, the electric machine can be controlled effectively. In the DC boost charging mode, the three-phase windings in the wire slots of the electric machine stator are configured to be used as the inductive energy storage element of the DC boost charging circuit, the inductive energy storage element and the three-phase inverter together forming the DC boost charging circuit, such that the external power supply module charges the external power battery by means of the DC boost charging circuit; in this way, the electric machine control circuit can be used for the additional purpose of realizing the boost charging process for the external power battery. Furthermore, by setting the number of wire slots in the stator to be at least 54, compared with an electric machine control circuit currently applied in a DC boost charging circuit (in which the number of wire slots in the stator of the three-phase AC electric machine is generally 48), i.e. by increasing the number of wire slots in the electric machine stator, the inductance of the three-phase windings in the electric machine can be increased effectively, such that when the three-phase windings are used as the inductive energy storage element of the DC boost charging circuit, the voltage stability and reliability of the boost charging process can be ensured, thus realizing an efficient and reliable charging process. In addition, increasing the number of wire slots in the stator also optimizes the structure of the three-phase AC electric machine, helping to achieve a high rotation speed and high torque output. Thus, the design in the present application can simultaneously achieve optimization of the boost charging function (high electric machine inductance) and optimization of the output performance of the electric machine itself (high electric machine rotation speed).

In some embodiments, the inductive energy storage element is formed solely by the three-phase windings in the wire slots of the electric machine stator of the three-phase AC electric machine 111.

In the present application, as a result of configuring the inductive energy storage element to be formed solely by the three-phase windings in the wire slots of the electric machine stator of the three-phase AC electric machine 111, it is possible to effectively realize the boost charging process for the power battery in the DC boost charging mode by means of the inductive energy storage element formed by the three-phase windings in the at least 54 wire slots, without the need for an additional component, and in particular without the need for an additional inductive element to assist the boost charging process; thus, the circuit structure of the DC boost charging circuit is considerably simplified, and costs are lowered.

In some embodiments, the wire slots are 54 wire slots, 60 wire slots, 66 wire slots or 72 wire slots.

Configuring the wire slots in the stator to be 60 wire slots, 66 wire slots or 72 wire slots has the following effects, based on simultaneous consideration of electric machine operating performance: firstly, the larger number of wire slots in the stator makes it possible to further increase the inductance of the three-phase windings of the electric machine, and thus effectively realize a stable and reliable boost charging process; secondly, the increased number of wire slots in the stator makes it possible to reduce the rotor diameter in order to achieve a high rotation speed output, while also enabling the electric machine to maintain a high torque output, thus helping to achieve a high rotation speed and high torque output of the electric machine.

In some embodiments, the electric machine stator has 6 magnetic poles.

Providing 6 magnetic poles helps to lower the core loss of the electric machine. Specifically, the expression for the core loss of an electric machine is as follows:

$$CoreLoss = {k}_{h} {fB}^{2} + {k}_{c} {f}^{2} {B}^{2} + {{k}_{e} ( fB )}^{1.5} \qquad 2 )$$

where CoreLoss represents the core loss of the electric machine, kₕ, k_{c} and kₑ are parameters chosen according to actual needs, f is the operating frequency of the electric machine, and B is intended to represent the size of an external magnetic field.

It is known based on the above that the electric machine core loss is directly proportional to the electric machine operating frequency, and it is known that the electric machine operating frequency is related to the electric machine rotation speed and the number of magnetic pole pairs in the electric machine. Thus, it is known that when a smaller number of magnetic poles is chosen (i.e. the number of magnetic pole pairs is reduced), the electric machine operating frequency can be reduced, such that the electric machine has a lower core loss; in this way, the efficiency of the electric machine is increased.

In the present application, by configuring the electric machine stator to have 6 magnetic poles, firstly, the core loss can be reduced in comparison to an electric machine stator with 8 magnetic poles, thereby improving the electric machine performance. Secondly, 6 magnetic poles are compatible with the case where the number of wire slots in the stator is 54, 60, 66 or 62, thus achieving good electric machine motion characteristics while increasing the inductance of the three-phase windings of the electric machine.

Especially preferably, the electric machine stator may for example be configured to have 54 wire slots and 6 magnetic poles; this makes it possible to simultaneously give consideration to achieving high winding inductance, high nominal rotation speed and low core loss and reducing manufacturing process complexity, based on the use of the electric machine control circuit for the additional purpose of boost charging.

In some embodiments, the electric machine stator has 8 magnetic poles, and the wire slots are 72 wire slots.

Based on the above, in the present application, configuring the electric machine stator to have 8 magnetic poles and 72 wire slots has the following effect: when the stator magnetic pole configuration of 8 magnetic poles is used, good electric machine operating performance is achieved by providing 72 wire slots to match this configuration. Moreover, further increasing the number of wire slots in the electric machine makes it possible to further increase the inductance of the three-phase windings of the electric machine, and makes it easier to simultaneously give consideration to high rotation speed and high torque output of the electric machine.

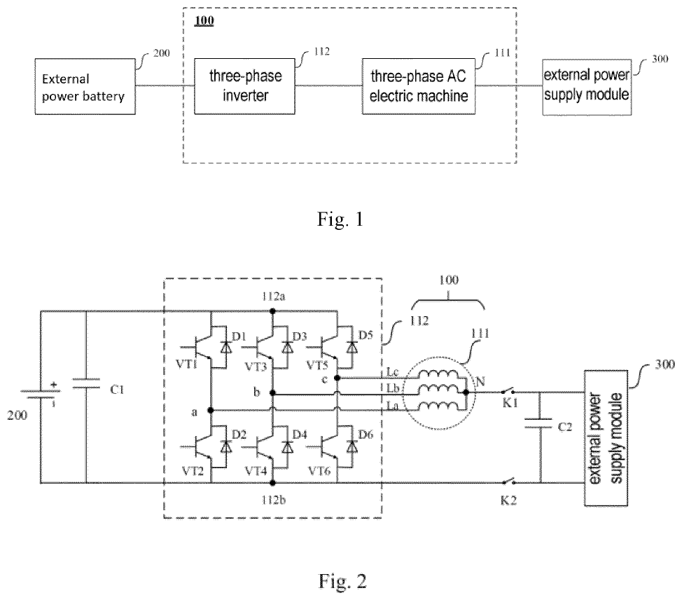

In some embodiments, the manner in which the three-phase inverter and the three-phase AC electric machine are connected may for example be explained in further detail. FIG. 2 shows a circuit diagram of the electric machine control circuit 100 according to embodiments of the present disclosure.

Referring to FIG. 2, this shows the three-phase AC electric machine 111, the three-phase inverter 112, the external power battery 200 and the external power supply module 300.

Moreover, as shown in FIG. 2, in the DC boost charging mode, a first end 112a of the three-phase inverter 112 is electrically connected to the external power battery 200, and a second end 112b of the three-phase inverter 112 is electrically connected to the external power supply module 300 and the external power battery 200.

Moreover, the midpoints of the three-phase bridge arms of the three-phase inverter 112 are each connected to a corresponding end of the three-phase windings of the three-phase AC electric machine, with the other ends of the three-phase windings of the three-phase AC electric machine being electrically connected to the external power supply module 300 via a common connection point N.

For example, referring to FIG. 2, the midpoint of a first-phase bridge arm in the three-phase bridge arms is for example a, and the midpoint a of the first-phase bridge arm is for example connected to a corresponding end of a first-phase winding La; the midpoint b of the second-phase bridge arm is for example connected to a corresponding end of the second-phase winding Lb; and the midpoint c of the third-phase bridge arm is for example connected to a corresponding end of the third-phase winding Lc.

Based on the above, in the present application, by configuring the specific connection relationship of the three-phase inverter and the three-phase AC electric machine, specifically, by configuring the first end of the three-phase inverter to be electrically connected to the external power battery and the second end of the three-phase inverter to be electrically connected to the external power supply module and the external power battery, and configuring the midpoints of the three-phase bridge arms of the three-phase inverter to be each connected to a corresponding end of the three-phase windings of the three-phase AC electric machine, with the other ends of the three-phase windings of the three-phase AC electric machine being electrically connected to the external power supply module via the common connection point, the electric machine control circuit is enabled to perform its functions effectively in both the electric machine drive mode and the DC boost charging mode. In particular, this connection relationship makes it easy to use the three-phase windings of the three-phase AC electric machine additionally as an inductive energy storage element in the DC boost charging mode, to realize the boost charging process for the external power battery.

In some embodiments, as shown in FIG. 2, in the DC boost charging mode, the common connection point N of the three-phase windings of the three-phase AC electric machine is electrically connected to the external power supply module 300, such that no additional inductive element is provided between the common connection point N and the external power supply module 300.

It should be understood that the statement “the common connection point N of the three-phase windings of the three-phase AC electric machine is electrically connected to the external power supply module 300, such that no additional inductive element is provided between the common connection point N and the external power supply module 300” appearing at this point in the present application is intended to explain that no inductive element for assisting the boost operation is provided between these two electrical components, i.e. the common connection point N and the external power supply module 300, and not intended to impose a restriction that no additional electrical component is provided between these two electrical elements. Depending on actual needs, it is generally also possible to provide another electrical element between the common connection point N of the three-phase windings of the three-phase AC electric machine and the external power supply module 300, e.g. a switching element K1, a relay, a connector or another electrical component, in order to to achieve a stable and reliable connection between the three-phase windings and the external power supply module.

Moreover, the second end of the three-phase inverter is electrically connected to the external power supply module, such that no additional inductive element is provided between the second end of the three-phase inverter and the external power supply module.

It should be understood that the statement “no additional inductive element is provided between the second end of the three-phase inverter and the external power supply module” appearing at this point in the present application is intended to explain that no inductive element for assisting the boost operation is provided between these two electrical components, and not intended to impose a restriction that no additional electrical component is provided between these two electrical elements. Depending on actual needs, another electrical element such as a switching element K2, etc. may also be provided between the second end of the three-phase inverter and the external power supply module.

Based on the above, as a result of not providing an additional inductive element between the common connection point of the three-phase windings of the three-phase AC electric machine and the external power supply module, and not providing an additional inductive element between the second end of the three-phase inverter and the external power supply module, only the three-phase windings of the three-phase AC electric machine with at least 54 wire slots are used as the inductive energy storage element in the DC boost charging circuit, based on the use of the electric machine control circuit for the additional purpose of boost charging. Thus, the volume of the DC boost charging circuit can be considerably reduced while the boost charging function is realized effectively, and the structural complexity of the circuit is reduced.

In some embodiments, the nominal rotation speed of the three-phase AC electric machine is at least 17000 r/min.

For example, depending on actual needs, the nominal rotation speed of the three-phase AC electric machine may for example reach 17000 r/min, 18000 r/min, 19000 r/min or 20000 r/min.

Based on the above, in the present application, by appropriately configuring the magnetic poles and wire slots of the three-phase AC electric machine, e.g. configuring them to be 54 wire slots and 6 magnetic poles, the three-phase AC electric machine is enabled to achieve a high nominal rotation speed, e.g. a nominal rotation speed greater than or equal to 17000 r/min, such that the three-phase AC electric machine is able to effectively achieve a high rotation speed output, thus effectively improving the operating performance of the three-phase AC electric machine.

In some embodiments, the nominal rotation speed of the three-phase AC electric machine is 20000 r/min.

The configuration of the magnetic poles and wire slots of the three-phase AC electric machine in the present application enables the nominal rotation speed of the three-phase AC electric machine to reach 20000 r/min; compared with an existing nominal rotation speed of 16000 r/min, the output rotation speed of the three-phase AC electric machine can be significantly increased in the present application, achieving a higher rotation speed output, further improving the operating performance of the three-phase AC electric machine, and helping to make the three-phase AC electric machine adaptable to a variety of different application scenarios.

The electric machine control circuit 100 shown in FIG. 2 and the DC boost charging mode thereof are now explained in further detail, for example with reference to a particular application scenario.

Again referring to FIG. 2, this shows the three-phase AC electric machine 111, the three-phase inverter 112, the external power battery 200 and the external power supply module 300. Moreover, the three-phase AC electric machine 111 for example is a permanent magnet synchronous electric machine, and uses a three-phase, four-wire system, i.e. current is inputted or outputted through an N line led out from the connection point N of the three-phase windings.

The three-phase inverter comprises six switching control elements, wherein the switching control elements are transistors, an upper and a lower switching control element form a bridge arm of one phase, and these bridge arms together form the three-phase bridge arms. Specifically, a transistor VT1 and a transistor VT2 form the first-phase bridge arm, a transistor VT3 and a transistor VT4 form the second-phase bridge arm, a transistor VT5 and a transistor VT6 form the third-phase bridge arm, and as stated above, the midpoints of the three-phase bridge arms of the three-phase inverter are each connected to a corresponding end of the three-phase windings of the three-phase AC electric machine.

Diodes D1, D2, D3, D4, D5 and D6 are also provided in the three-phase inverter, and each switching control unit in the three-phase inverter is connected in anti-parallel with the corresponding diode; for example, taking the first bridge arm as an example, the transistor VT1 and the diode D1 in the upper bridge arm therein are connected in anti-parallel, while the transistor VT2 and the diode D2 in the lower bridge arm are connected in anti-parallel. Moreover, a capacitor C1 and a capacitor C2 are also provided in the circuit, wherein the capacitor C1 is connected in parallel with the external power battery, the capacitor C2 is connected in parallel with the external power supply module, and the capacitances of the capacitors C1, C2 may for example be chosen according to actual needs.

Moreover, switches K1, K2 are also provided in the circuit; these are configured to be in an OFF or ON state according to the operating mode of the electric machine control circuit, in order to connect the external power supply module 300 in the process of boost charging, and disconnect the external power supply module from the electric machine control circuit in the process of electric machine drive, thereby preventing the power supply module from influencing the electric machine drive process.

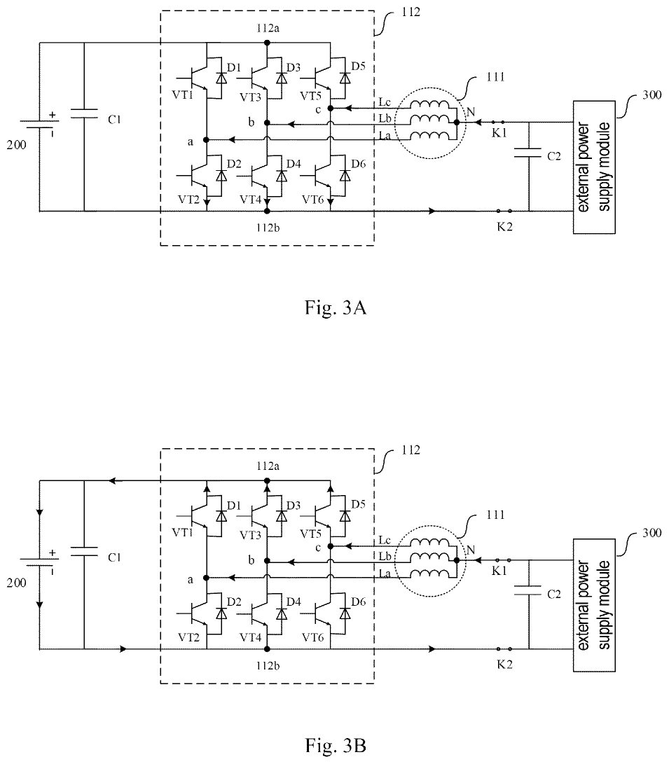

The boost charging process is now described in further detail with reference to FIGS. 3A and 3B. The boost charging process for example comprises a first stage and a second stage. In the first stage, the external power supply module charges the three-phase windings of the three-phase AC electric machine; in the second stage, the external power supply module and the three-phase windings of the three-phase AC electric machine together charge the power battery. FIG. 3A shows the current flow direction when the electric machine control circuit 100 in FIG. 2 is in the first stage of the DC boost charging mode, in which the external power supply module charges the three-phase windings of the three-phase AC electric machine; FIG. 3B shows the current flow direction when the electric machine control circuit 100 in FIG. 2 is in the second stage of the DC boost charging mode, in which the external power supply module and the three-phase windings of the three-phase AC electric machine together charge the power battery.

Referring to FIG. 3A, in the DC boost charging mode, firstly, in the first stage, the external power supply module charges the three-phase windings of the three-phase AC electric machine; at this time, the switches K1, K2 are in a closed state, such that the external power supply module can be connected to the electric machine control circuit. The external power supply module mentioned here may for example be a DC charging post on a road. Moreover, at this time, the three-phase windings in the wire slots of the electric machine stator of the three-phase AC electric machine 111 are used as the inductive energy storage element of the DC boost charging circuit; the inductive energy storage element and the three-phase inverter 112 together form the DC boost charging circuit. At this time, the transistors VT2, VT4, VT6 in the three-phase inverter may for example be controlled to be in the ON state, while the transistors VT1, VT3, VT5 in the three-phase inverter are controlled to be in the OFF state, such that all of the lower bridge arms of the three-phase bridge arms in the three-phase inverter are in the ON state and all of the upper bridge arms of the three-phase bridge arms are in the OFF state. At this time, the external power supply module, the three-phase windings Lc, Lb, La of the three-phase AC electric machine, and the three-phase lower bridge arms in the three-phase inverter form a first charging loop. The external power supply module for example charges the three-phase windings of the three-phase AC electric machine via the first charging loop, wherein the flow direction of current in the first charging loop is as shown in FIG. 3A.

Thereafter, referring to FIG. 3B, after charging the three-phase windings of the three-phase AC electric machine, in the second stage the transistors VT1, VT3, VT5, VT2, VT4, VT6 in the three-phase inverter may for example be further controlled to all be in the OFF state. At this time, all of the lower bridge arms of the three-phase bridge arms are in the OFF state, and the three-phase windings of the three-phase AC electric machine may for example be connected to the power battery via the diodes D1, D3, D5 in the upper bridge arms of the three-phase inverter. At this time, the external power supply module, the three-phase windings Lc, Lb, La of the three-phase AC electric machine, and the three-phase upper bridge arms in the three-phase inverter form a second charging loop; an output voltage of the external power supply module and an output voltage of the three-phase windings are superposed and together used to charge the power battery, thus boosting the voltage of the external power supply module, and thereby realizing a stable and reliable boost charging process.

Moreover, the three-phase AC electric machine for example has an electric machine structure with 54 wire slots and 6 poles.

As stated above, the 54-wire-slot configuration significantly increases the inductance of the three-phase windings of the three-phase AC electric machine. For example, compared with a 48-wire-slot configuration (the winding of each phase corresponds to 16 wire slots, i.e. corresponds to 16 series-connected turns), in the 54-wire-slot configuration the winding of each phase corresponds to 18 wire slots, i.e. the winding of each phase has 18 series-connected turns. Thus, the number of series-connected turns in the winding of each phase is significantly increased, thereby increasing the inductance of the winding of each phase.

Furthermore, configuring 54 wire slots also optimizes the performance of the electric machine itself. Firstly, the 54-wire-slot configuration enables an electric machine rotor with a smaller rotor outer diameter to be accommodated, and the smaller rotor outer diameter helps to achieve a high rotation speed output of the electric machine. Secondly, at the same time as achieving a high rotation speed, the 54-wire-slot configuration also makes it easier to give consideration to output torque while increasing the rotation speed. Thus, the electric machine has a high output torque as well as a high rotation speed. In addition, by further configuring the three-phase AC electric machine to have 6 magnetic poles, i.e. by having it employ a structural configuration of 54 wire slots and 6 poles, a reduction in core loss is achieved through a smaller number of magnetic poles (6 poles).

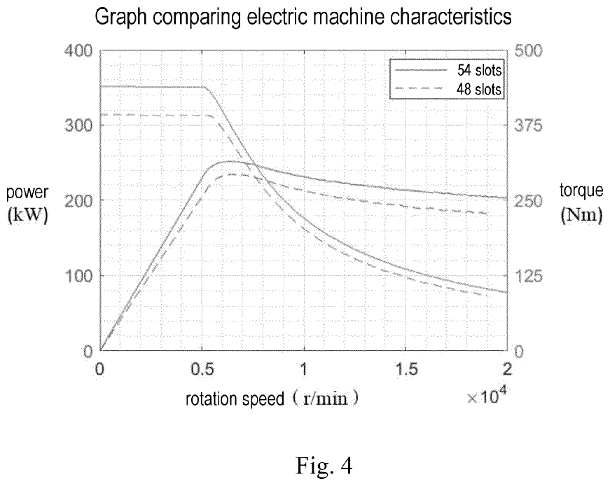

FIG. 4 shows a graph comparing the performances of an electric machine with 54 wire slots and 6 poles according to embodiments of the present disclosure and an electric machine with 48 wire slots and 8 poles.

Referring to FIG. 4, this shows the performances of the electric machine with 54 wire slots and the electric machine with 48 wire slots at different rotation speeds, in particular the performances in terms of torque and power. Specifically, the electric machine types compared here are an electric machine with 54 wire slots and 6 poles and an electric machine with 48 wire slots and 8 poles. It can be seen from the graph comparing electric machine characteristics in FIG. 4 that, at each rotation speed setting, the performance of the electric machine with 54 wire slots in terms of power and torque is better than that of the electric machine with 48 wire slots. In particular, although a rotor with a smaller outer diameter is used in the electric machine with 54 wire slots, the output torque of the electric machine with 54 wire slots can still be maintained at substantially the same level as the output torque of the electric machine with 48 wire slots (in which a rotor with a larger outer diameter is installed). The electric machine with 54 wire slots, while adapted to a smaller rotor outer diameter to achieve a high rotation speed, can also maintain output torque at a high level, thus simultaneously giving consideration to high rotation speed and high torque output.

According to another aspect of the present disclosure, an electric drive assembly system is proposed, which for example comprises the electric machine control circuit as described above.

The electric drive assembly system is a system used to realize drive control of a drive electric machine (three-phase AC electric machine) of the vehicle. The electric drive assembly system for example may further comprise other electrical components or apparatuses, depending on actual needs. The embodiments of the present disclosure are not restricted by the specific composition of the electric drive assembly system or the types of components included therein.

Based on the above, in the present application, configuring the electric drive assembly system to comprise the electric machine control circuit makes it possible, in the electric machine drive mode, to receive DC power from the external power battery by means of the three-phase inverter and output AC power for driving the three-phase AC electric machine, to control the electric machine effectively. Moreover, in the DC boost charging mode, the three-phase windings in the wire slots of the electric machine stator are used as the inductive energy storage element of the DC boost charging circuit, the inductive energy storage element and the three-phase inverter together forming the DC boost charging circuit, such that the external power supply module charges the external power battery by means of the DC boost charging circuit; in this way, the electric machine control circuit can be used for the additional purpose of realizing the boost charging process for the external power battery. Furthermore, by setting the number of wire slots in the stator to be at least 54, compared with an electric machine control circuit currently applied in a DC boost charging circuit (in which the number of wire slots in the stator of the three-phase AC electric machine is generally 48), i.e. by increasing the number of wire slots in the electric machine stator, the inductance of the three-phase windings in the electric machine can be increased effectively, such that when the three-phase windings are used as the inductive energy storage element of the DC boost charging circuit, the voltage stability and reliability of the boost charging process can be ensured, thus realizing an efficient and reliable charging process. In addition, increasing the number of wire slots in the stator also optimizes the structure of the three-phase AC electric machine, helping to achieve a high rotation speed and high torque output. Thus, the design in the present application can simultaneously achieve optimization of the boost charging function (high electric machine inductance) and optimization of the output performance of the electric machine itself (high electric machine rotation speed).

In some embodiments, the electric machine control circuit in the electric drive assembly system may for example have the structure described above, and is able to perform the functions described above.

According to another aspect of the present disclosure, a vehicle is also proposed. The vehicle for example comprises the electric drive assembly system described above.

The vehicle is for example a pure electric vehicle or a hybrid vehicle.

Based on the above, in the present application, configuring the vehicle to comprise the electric drive assembly system makes it possible, in the electric machine drive mode, to receive DC power from the external power battery by means of the three-phase inverter and output AC power for driving the three-phase AC electric machine, to control the electric machine effectively. Moreover, in the DC boost charging mode, the three-phase windings in the wire slots of the electric machine stator are used as the inductive energy storage element of the DC boost charging circuit, the inductive energy storage element and the three-phase inverter together forming the DC boost charging circuit, such that the external power supply module charges the external power battery by means of the DC boost charging circuit; in this way, the electric machine control circuit can be used for the additional purpose of realizing the boost charging process for the external power battery, and it is thus possible to realize multiple different operating modes in a simple and convenient manner, while simplifying the internal circuitry of the vehicle. Furthermore, by configuring the wire slots of the stator to be at least 54 wire slots, it is possible to effectively increase the inductance of the three-phase windings in the electric machine, to ensure the voltage stability and reliability of the boost charging process, and realize an efficient and reliable charging process. In addition, the structure of the three-phase AC electric machine is optimized, helping to achieve a high rotation speed and high torque output.

In some embodiments, the electric drive assembly system of the vehicle may for example comprise an electric machine control circuit, and for example may have the structure described above, and be able to perform the functions described above.

In the present application, specific terms are used to describe embodiments of the present application. For example, “first/second embodiment”, “an embodiment” and/or “some embodiments” refer to a feature, structure, or characteristic relevant to at least one embodiment of the present application. Therefore, it should be stressed and noted that “an embodiment”, “one embodiment” or “an alternative embodiment” mentioned two or more times in different places herein does not necessarily refer to the same embodiment. In addition, certain features, structures or characteristics in one or more embodiments of the present application may be combined appropriately.

Unless otherwise defined, all of the terms (including technical and scientific terms) used herein have the same meanings as those commonly understood by those skilled in the art. It should also be understood that terms such as those generally defined in a dictionary should be interpreted as having the same meanings as in the context of the related art, rather than being interpreted in an idealized or extremely formalised sense, unless expressly so defined herein.

The above is a description of the present disclosure and should not be regarded as limiting it. Although certain exemplary embodiments of the present disclosure have been described, those skilled in the art will readily understand that many modifications may be made to the exemplary embodiments without departing from the novel teaching and advantages of the present disclosure. Therefore, all such modifications are intended to be included within the scope of the present disclosure as defined by the claims. It should be understood that the above is a description of the present disclosure, and should not be deemed to be limited to the specific embodiments disclosed; in addition, modifications made to the disclosed embodiments and other embodiments are intended to be included within the scope of the attached claims. The present disclosure is defined by the claims and their equivalents.

1. An electric machine control circuit, comprising:
a three-phase AC electric machine;
a three-phase inverter, wherein, in an electric machine drive mode, the three-phase inverter is configured to receive DC power from an external power battery and output AC power for driving the three-phase AC electric machine, and in a DC boost charging mode, three-phase windings in wire slots of an electric machine stator of the three-phase AC electric machine are used as an inductive energy storage element of a DC boost charging circuit, the inductive energy storage element and the three-phase inverter together forming the DC boost charging circuit, such that an external power supply module charges the external power battery by means of the DC boost charging circuit,
wherein the wire slots are at least 54 wire slots.

2. The electric machine control circuit according to claim 1, wherein the inductive energy storage element is formed solely by the three-phase windings in the wire slots of the electric machine stator of the three-phase AC electric machine.

3. The electric machine control circuit according to claim 1, wherein the wire slots are 54 wire slots, 60 wire slots, 66 wire slots or 72 wire slots.

4. The electric machine control circuit according to claim 3, wherein the electric machine stator has 6 magnetic poles.

5. The electric machine control circuit according to claim 1, wherein the electric machine stator has 8 magnetic poles, and the wire slots are 72 wire slots.

6. The electric machine control circuit according to claim 1, wherein, in the DC boost charging mode, a first end of the three-phase inverter is electrically connected to the external power battery, and a second end of the three-phase inverter is electrically connected to the external power supply module and the external power battery;
and wherein the midpoints of three-phase bridge arms of the three-phase inverter are each connected to a corresponding end of the three-phase windings of the three-phase AC electric machine, with the other ends of the three-phase windings of the three-phase AC electric machine being electrically connected to the external power supply module via a common connection point.

7. The electric machine control circuit according to claim 6, wherein, in the DC boost charging mode, the common connection point of the three-phase windings of the three-phase AC electric machine is electrically connected to the external power supply module, such that no additional inductive element is provided between the common connection point and the external power supply module.

8. The electric machine control circuit according to claim 1, wherein the nominal rotation speed of the three-phase AC electric machine is at least 17000 r/min.

9. The electric machine control circuit according to claim 8, wherein the nominal rotation speed of the three-phase AC electric machine is 20000 r/min.

10. An electric drive assembly system, comprising the electric machine control circuit according to claim 1.

11. A vehicle, comprising the electric drive assembly system according to claim 10.

12. The electric machine control circuit according to claim 2, wherein the wire slots are 54 wire slots, 60 wire slots, 66 wire slots or 72 wire slots.

13. The electric machine control circuit according to claim 2, wherein the electric machine stator has 8 magnetic poles, and the wire slots are 72 wire slots.

14. The electric machine control circuit according to claim 2, wherein, in the DC boost charging mode, a first end of the three-phase inverter is electrically connected to the external power battery, and a second end of the three-phase inverter is electrically connected to the external power supply module and the external power battery;
and wherein the midpoints of three-phase bridge arms of the three-phase inverter are each connected to a corresponding end of the three-phase windings of the three-phase AC electric machine, with the other ends of the three-phase windings of the three-phase AC electric machine being electrically connected to the external power supply module via a common connection point.

15. The electric machine control circuit according to claim 2, wherein the nominal rotation speed of the three-phase AC electric machine is at least 17000 r/min.

16. An electric drive assembly system, comprising the electric machine control circuit according to claim 2.

17. An electric drive assembly system, comprising the electric machine control circuit according to claim 3.

18. An electric drive assembly system, comprising the electric machine control circuit according to claim 4.

19. An electric drive assembly system, comprising the electric machine control circuit according to claim 5.

20. An electric drive assembly system, comprising the electric machine control circuit according to claim 6.
